(19) United States
(12) Patent Application Publication
(10) Pub. No.: US 2005/0203982 A1
(43) Pub. Date: Sep. 15, 2005

(54) Method and apparatus for approximating, deconvolving and interpolating data using berstein functions

(76) Inventor: Joseph Kolibal, Hattiesburg, MS (US)

Correspondence Address: HOWREY SIMON ARNOLD & WHITE, LLP, c/o IP DOCKETING DEPARTMENT, 2941 FAIRVIEW PARK DRIVE, SUITE 200, FALLS CHURCH, VA, 22042-2924, US

(21) Appl. No.: 11/056,982

(22) Filed: Feb. 11, 2005

Related U.S. Application Data
(60) Provisional application No. 60/544,975, filed on Feb. 13, 2004.

(51) Int. Cl. G06F 17/15

(52) U.S. Cl. 708/420

(57) ABSTRACT

Given data on a bounded interval, e.g., of the form (Xᵢ,Yᵢ), the patent describes a unified approach which accomplishes data regularization, i.e., data approximation, function recovery high frequency filtering, and interpolation based on the use of discrete linear stochastic de-convolution and re-convolution operators. The construction of these operators is developed from an extension of the Bernstein polynomials, which the patent denotes as Bernstein functions, and extends broadly to any mollifier which can be normalized to yield a probability density function. This new technique can be applied to a variety of problems, including those involving multidimensional data regularization. The regularized representations of data processed using stochastic data regularization through the use of Bernstein functions allows for smooth interpolation of even very rough, noisy data that is remarkably free of wiggles or spurious oscillations.

This application claims the benefit of U.S. Provisional Patent Application No. 60/544,975 filed Feb. 13, 2004 and entitled “Method And Apparatus For Approximating, Deconvolving And Interpolating Data Using Berstein Functions” by Kolibal, and incorporates that application by reference.

### BACKGROUND OF THE INVENTION

The invention is in the field of numerical analysis and applied mathematics as well as the fields to which these disciplines are applied. The methods, systems and descriptions described in the patent may be applied to data analysis and manipulation for both large and small databases. The methods, systems and descriptions may also have applications in serial, multiprocessor and parallel applications.

The ability to accurately interpolate or construct appropriate functional approximations between data points is useful for many engineering and science applications with incomplete data sets. For example, see U.S. Pat. Nos. 6,091,862 and 6,052,427. In the case of data approximation (data filtering, data smoothing and recovery), the invention provides for highly accurate approximations with very controllable smoothing and provides a uniform approximation to the data, i.e., with no spurious extrema being introduced (wiggles). The stochastic data regularization method when constructed using the Bernstein functions asymptotically preserves the norm of the data and yields a smooth, i.e., C^{∞} curve. In the case of interpolation, false extrema and spurious wiggles can be minimized (near monotonicity) for even highly oscillatory data representing functions with discontinuities. These benefits are difficult to achieve with any currently used techniques for approximating or interpolating data.

### SUMMARY

The method described performs stochastic data regularization. The methods for data regularization may be used for interpolation, data recovery, data deconvolution, data approximation, data error filtration and smoothing. The method includes inputting a set of input data elements to be regularized. The data elements in the method include a value and a position and may also be a unit coordinate vector.

A stochastic convolution matrix is then constructed using the position of the input data elements, a normalized convolution operator and Bernstein Functions. In some instances the method then creates and applies the inverse of the stochastic convolution matrix to the values of the set of input data elements to create a preimage of the data.

The method then constructs a stochastic reconvolution matrix with Bernstein Functions and a normalized convolution operator, consistent with the stochastic convolution matrix and using desired positions for a set of output data elements. The method then applies the stochastic reconvolution matrix to the preimage of the data to create the set of output data elements.

The data regularization methods may be implemented in a variety of ways and with different systems. A special purpose processor or ASIC, or a dedicated portion of these may implement the methods. Software stored in any form such as a hard drive or ROM executing on a general purpose processor may also implement the methods. The methods may be integrated into a larger program or may be stand-alone. If stand-alone, the interpolation may be executed in a variety of manners, including through a command line interface or a web-browser.

### A BRIEF DESCRIPTION OF DRAWINGS

FIGS. 1(a) and 1(b) demonstrate smoothing using Bernstein polynomials Bₙ (solid line).

FIG. 2 demonstrates the convergence of \hat{K}ₙ to the function f(x)=1,x∈[0,1] using (a) n=20 points, (b) n=100 points.

FIG. 3 shows approximating f (x)=cos(12πx) at 100 points (crosses) with a) α=x(1−x)/2 and b) α=x(1−x)=16 using K₁₀₀ (solid line).

FIGS. 4(a)-(d) show a method of function recovery.

FIG. 5 demonstrates constructing b₁₄ using α=1 and aα= 1/10 amounts to interpolating a unit impulse located at x=14.

FIG. 6 demonstrates comparing the graph of sin(x) sampled at 12 points on [0;2π] with its Bernstein interpolant, J₁₂(x).

FIG. 7 demonstrates comparing the graph of f(x)=x cos(x/2)sin(2x) sampled at 101 points on [0:100] with its Bernstein interpolant, J₁₀₁(x). Only the range from 75 to 80 is plotted.

FIG. 8 is a system that executes a method of the invention.

FIG. 9 is a display of an exemplary output of results of the invention.

### DETAILED DESCRIPTION

1. Generally

The construction of Bernstein functions is based on extensions of the Bernstein polynomials and there are several constructions possible for Bernstein functions. The construction of the Bernstein function yields a technique for approximating a given function f(x) which is sampled at n points (xᵢ,f(xᵢ)), or equivalently data (xᵢ,yᵢ). The Bernstein functions can be constructed so that that for large values of n, i.e., the number of data or sample point, they yield results which converge to those given by Bernstein polynomials.

Stochastic data approximation includes processes by which a stochastic convolution matrix is applied to a set of data to produce a smoother output set of data. This results in an approximation to the input data, and achieves smoothing and control of noise when used with effective mollifiers such as the Bernstein functions. The method's matrix structure evaluates the Bernstein function of the input data, and is therefore a method smoothing or mollifying the data. This method provides a framework in which data approximation can be extended easily to describe data interpolation and de-convolution (e.g., peak sharpening).

The processes of data interpolation or de-convolution includes a two step process involving a de-convolution and re-convolution step. The methods described are thus subsumed into a broader framework for constructing a stochastic matrix (usable for stochastic data approximation), and then using its inverse to construct a pre-image of the data. This corresponds to the process of de-convolution provided that the stochastic matrix includes entries constructed so that the row space acts as mollifiers of data. The multiplication of this pre-image by an augmented stochastic matrix corresponding to the process of re-convolving the pre-image provides a more generic framework for the convolution-deconvolution process. The Bernstein functions provide a convenient and robust method of constructing the convolution matrices which serve as de-convolution and re-convolution operators. Thus, through this construction involving stochastic matrices, the processes of data approximation, interpolation, and de-convolution fits into a broader unified framework for accomplishing a broad range of tasks associated with data regularization.

The processes described can be performed in more than one-dimension. Also, there is no need that the data be regularly spaced (e.g., as on a uniform grid). Furthermore, the operations include only the accumulation of sums and thus can be parallelized.

The method includes constructing mollifiers for constructing row spaces of stochastic data regularization matrices. This is done by an extension of the Bernstein polynomials, and showing that these extensions, known as Bernstein functions, can be done many ways, however a particular subclass of these extensions' functions have useful and desirable properties for data approximation.

The process of approximation and function recovery from data regularization using these functions is described for data regularization. This is done by taking a Bernstein function (by way of example) and showing that the task of approximation amounts to applying a linear matrix stochastic operator to the data. Applying a Bernstein function for approximation, is shown to be equivalent to the application of discrete convolution matrix to the data. Extending this one step convolution process, i.e., data approximation, to a two step process including first de-convolving the data, and then re-convolving it achieves data interpolation and de-convolution.

The disclosure includes a solution for the problem of constructing a usable fit to data generated by sampling a smooth function to which noise has been added. Given data (xₖ,fₖ) of the form:
fₖ=u(xₖ)+εₖ, k=0, 1, . . . , n, (1.1)
construct an approximation un to the data which: a) captures the underlying behavior of u at each fixed n; and b) converges (rapidly) to u as n becomes large. As u is suitably smooth and that the data are comprised of perturbations of the function u by εₖ at the sampled points xₖ poses a challenge in reconstructing u from the n+1 data points, {(xₖ,fₖ)}. This reconstruction can be viewed as smoothing or filtering the errors, or as a function recovery.

A direct approach, employed in engineering and signal analysis to recover u, is to create low pass filters designed to smooth out high frequency components which are assumed to correspond to the error or perturbations to the data. More typically, this is often posed in the least squares sense in which the intent is to find g to minimize

$$\frac{1}{n + 1} {\sum }_{k = 0}^{n} {( {f}_{k} - g ( {x}_{k} ) )}^{2} + λ {\int }_{0}^{1} {( {g}^{( m )} ( x ) )}^{2} ⅆ x , \qquad ( 1.2 )$$

for some λ>0. Taking λ=0 minimizes the error (fₖ−g(xₖ)) in the least squares sense, while taking λ, different from zero provides an adjustable parameter which weights the minimization relative to the smoothness of g^{(m)} in L₂.

While functional considerations such as the growth of the derivatives of the approximant are important in selecting usable approximations to u, there are other criteria which may be considered. Since many processes are governed by conservation laws, it is often desirable to recover u in a manner which preserves the area under the data curve. Finding approximations uₙ using least squares methods, such as those in (1.2) which have filtered the noise while preserving the area under the data, is more difficult—requiring either constrained least squares fits or the use of iterative methods. Finally, constructing approximation includes that it be locally accurate, i.e., the construction balance the errors to achieve a uniform approximation, thereby avoiding the introduction of any spurious local maxima and minima.

For constructing smooth approximations to original functions while preserving the integrity of conservation and uniform approximation, the properties of Bernstein polynomials are strikingly apparent and attractive: Bernstein polynomials are area preserving and include many desirable monotonicity and smoothness properties that make them desirable for functional approximation. However, the use of Bernstein polynomials in data approximation, e.g., in constructing Bezier curves or B-splines, is usually limited to piecewise polynomial approximations using polynomial of relatively low degree. Furthermore, most computational methods typically only produce approximation of C², or C³ continuity across all nodes (typical of most splines). Quality control is typically achieved through a complex construction involving the placement of control points. Although the Bernstein polynomial allow for use of all of the data points (xₖ,fₖ) to obtain an approximation which meets all of the listed criteria, i.e., a C^{∞} uniform approximation to the data which converges uniformly to the function u while preserving the area under the data, in fact this is impractical. This is pointed out in many standard texts which cover the constructive proof of the Weierstrass Approximation theorem using Bernstein polynomials. These polynomials converge too slowly, even to other polynomials. e.g., p(x)=x². Instead, it is useful to develop extensions of the Bernstein polynomials such as Bernstein functions.

The disclosure discusses an approach to approximation using extensions of Bernstein polynomials. The disclosure describes efficiently computable extensions of these polynomials which retain the useful monotonicity and convergence properties of the Bernstein polynomials, while avoiding some undesirable properties which make the direct application of Bernstein polynomials difficult to the task. The disclosure provides a setting for the interpolation problem and the framework in which the overall problem of Bernstein approximation and interpolation can be set.

Some terms used in the disclosure described below:

1) Data regularization: The term data regularization subsumes several techniques for handling and manipulating data such as data approximation or interpolation. The common thread connecting these techniques is an attempt to represent data using functions whose analytical properties are more regular, i.e., they possess desirable and predictable analytical properties. For example, trying to find the best least squares fit to a set of data in the plane by a fifth degree polynomial, or finding the interpolating cubic spline which fits the data, typify the process of reducing a complex collection of data into a form which is more tractable from the viewpoint of numerically working with the data. Data regularization includes such common tasks as smoothing the data; filtering high frequency errors; convolving the data with mollifiers to smooth it; and finding functions which come close to the data using appropriate mathematical measures of the quality of the fit. This is also often referred to as function recovery because the objective is to recover, i.e., find a function from a larger class of functions which best represents the data.

2) Stochastic data regularization: Data regularization using stochastic matrices whose entries are generated using suitable mollifiers, e.g., the Bernstein functions, so that they can be used to discretely convolve data values to achieve a more regular representation of an input set of data values.

3) Position of a data element: Data which is processed or analyzed requires at least two quantities to be specified for each datum: a position (which may be implicit) and a value. A datum position specifies the location of a datum relative to a coordinate system. The datum position may be one dimensional, e.g., (x,v), where x denotes the position of the datum along a coordinate axis and v denotes the value of the datum at that coordinate value x, or it may be multi-dimensional, e.g., (z,v) where z=(x,y) and the datum is located in a two-dimensional coordinate system.

4) Value of a data element: The scalar or vector of numbers associated with each datum position. Input data: Input data consists of those data positions with corresponding data values to which data regularization is to be applied. Each datum is consists of coordinates pairs (xᵢ,vᵢ), and the collection of these constitutes an array of input data, (xᵢ,vᵢ), i=0, . . . , n, where n is the number of input data elements.

5) Output data: Output data consists of those data positions with corresponding data values to which data regularization has been applied. Each datum is consists of coordinates pairs (sᵢ,v₀ᵢ), and the collection of these constitutes an array of output data, (sᵢ,v₀ᵢ), i=0, . . . ,m, where m is the number of output data elements. Note that m need not be the same as n, the number of input data elements, and the position of the output data element may be distinct from the position of the input data elements.

6) Stochastic convolution matrix: The stochastic convolution matrix is a row stochastic matrix, i.e., each row sums to 1, that is generated so that each row discretely convolves a datum value when left multiplied by the matrix. Let v denote the array of input data values {vᵢ}k=1, . . . , n corresponding to the array of data positions x={xₖ}, k=0, . . . , n. Thus if Aₘₙ is an m+1 by n+1 stochastic convolution matrix, then Aₘₙv=s and s constitutes the array of convolved output data values. For example, when the stochastic convolution matrix is constructed using a Bernstein function K, each entry of the stochastic convolution matrix Aₘₙ=(αᵢⱼ), i=1, . . . , m,j=1, . . . , n, contains the term αᵢⱼ=K(xⱼ,sᵢ) where sᵢ denotes the position of an output data element, and xⱼ denotes the position of an input data element.

7) Pre-image: The pre-image, or pre-image of the data, consists of data values p which are obtained from the input data values v when the inverse of a square stochastic convolution matrix is applied to the array of data values, v={vᵢ} k=1, . . . , n. Thus if A⁻¹ₙₙ denotes the inverse of the stochastic convolution matrix, then A⁻¹ₙₙv=p and p constitutes the array of de-convolved data values, i.e., the pre-image of the data.

Among other applications, the method and system for data regularization described may be used for:

1) Data Approximation and Interpolation—The ability to accurately interpolate or construct appropriate functional approximations between data points is useful for many engineering and science applications with incomplete data sets. In the case of data approximation, the method provides for accurate approximation with very controllable smoothing and provides a uniform approximation to the data, with no spurious extrema being introduced (wiggles). In the case of interpolation, the original data points are included in all interpolated curves, and false extrema and spurious wiggles can be minimized (near monotonicity).

2) Data Recovery—Recovering the underlying characteristics of noisy data sets is useful for understanding the behavior of many processes. The method is able to accomplish this task well even for very noisy data for which the errors, i.e. the noise, approaches zero net deviation from the data on arbitrary subsets of the domain (that is, the noise statistically has a central tendency) For cases where the noise is markedly skewed away from this central limit, the results will reflect the skewing of the noise.

3. Data Error Filtration—Removing noise from data is useful in regard to improving the quality of the data. The method can be used to filter different frequency components of noisy data, thereby improving the quality of the data. This approach is valid so long as the noise is of much higher frequency than the signal, and the range of validity of the approach can be extended by combining this with spectral shift methods.

4. Data Deconvolution—De-convolving data enables the recovery of features not readily seen or understood within the existing image or data set. This feature has a broad range of applications in numerous medical, industrial, scientific, and military applications. Similar to data recovery, the methodology can be employed to recover image details, effectively de-blurring an image.

2. The Bernstein Polynomial.

Consider a Bernstein polynomial of order n approximating the function f(x), sampled at the n+1 equally spaced data points (xₖ,f(xₖ)),k=0, 1, . . . ,n,

$${B}_{n} ( f ; x ) = {\sum }_{k = 0}^{n} ( \begin{matrix}n \\ k\end{matrix} ) f ( {x}_{k} ) {{x}^{k} ( 1 - x )}^{n - k} . \qquad ( 2.1 )$$

where x∈[0,1] and

$$( \begin{matrix}n \\ k\end{matrix} )$$

denotes the combinatorial of n items taken k at a time, and where xᵢ=xᵢ₋₁+h, h=1/n with xₒ=0 and xₙ=1. By mapping [a,b], i.e., the domain off, to [0,1], f may be considered to be sampled on the unit interval.

The area under the graph of the Bernstein polynomial is

$$\begin{matrix}{\int }_{0}^{1} {B}_{n} ( f ; x ) ⅆ x = {\int }_{0}^{1} {\sum }_{k = 0}^{n} ( \begin{matrix}n \\ k\end{matrix} ) f ( {x}_{k} ) {{x}^{k} ( 1 - x )}^{n - k} ⅆ x \\ = {\sum }_{k = 0}^{n} ( \begin{matrix}n \\ k\end{matrix} ) f ( {x}_{k} ) {\int }_{0}^{1} {{x}^{k} ( 1 - x )}^{n - k} ⅆ x .\end{matrix} \qquad ( 2.2 )$$

Evaluating (2.2) using the Beta function,

$$\begin{matrix}{\int }_{0}^{1} {{x}^{α - 1} ( 1 - x )}^{β - 1} ⅆ x = Γ ( α ) Γ ( β ) / Γ ( α + β ) , \\ {\int }_{0}^{1} {B}_{n} ( f ; x ) ⅆ x = {\sum }_{k = 0}^{n} ( \begin{matrix}n \\ k\end{matrix} ) f ( {x}_{k} ) \frac{Γ ( k + 1 ) Γ ( n - k + 1 )}{Γ ( n + 2 )} \\ = {\sum }_{k = 0}^{n} \frac{n !}{k ! ( n - k ) !} f ( {x}_{k} ) \frac{k ! ( n - k ) !}{( n + 1 ) !} \\ = \frac{1}{n + 1} {\sum }_{k = 0}^{n} f ( {x}_{k} ) .\end{matrix} \qquad ( 2.3 )$$

Examining (2.3), the Bernstein polynomials have the property that the area under the curve Bₙ(f;x) is the same as the area under f(x) computed using piecewise constant quadrature in each interval [k/(n+1), (k+1)/(n+1)], k=0,1, . . . ,n. In keeping with a statistical formulation of the Bernstein polynomials, the sum is more consistent with Monte Carlo quadrature. As it turns out, the endpoint weighting is useful to developing extensions of the Bernstein polynomial which are uniformly convergent as will be demonstrated in Sec. 3.

$${\int }_{0}^{1} f ( x ) ⅆ x \approx \frac{1}{n + 1} {\sum }_{k = 0}^{n} f ( {x}_{k} ) . \qquad ( 2.4 )$$

While it may appear that the Bernstein polynomials could be applied to the problem of function recovery with area conservation, except for some fairly simple problems, there are some difficulties in taking this approach.

To illustrate this, consider the slowly oscillatory function u(x)=cos(2πx) sampled at the n+1 uniformly spaced points xₖ, k=0,1, . . . ,n, which is perturbed by the addition of a high frequency component, ε(x)=cos(50πx). The task in this case is to recover u(x) from the perturbed data {(xₖ,fₖ)}.

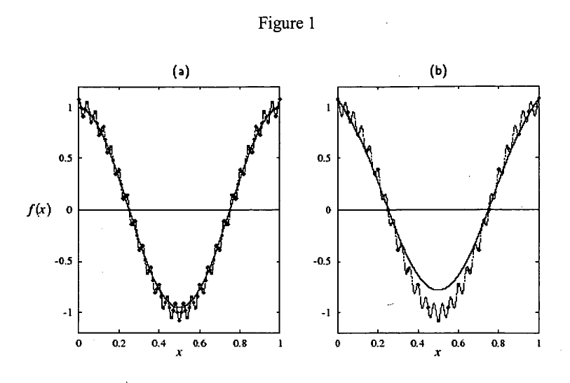

FIGS. 1(a) and 1(b) show the function u(x)=cos(2πx)+2 cos(50πx)=25 (dotted lines with markers showing the data points) sampled using (a) n=100 points and (b) n=20 points. The resulting Bernstein approximation is shown as a solid line. In FIG. 1(a) when n=100, the approximation B₁₀₀ correctly exhibits the sinusoidal behavior of cos(2πx), providing very effective filtration of the high frequency component cos(50πx). However, from FIG. 1(b) it is equally evident under sampling has the effect of over-smoothing the data. Since Bₙ→f and not u, it appears that too many data points (i.e., large n) can fail to provide any smoothing of high frequency errors.

Thus, the direct application of Bernstein polynomials to the problem of function recovery has a drawback that the smoothing is correlated with the number of points in the sample. In addition, the data is uniformly spaced along the interval.

3. An area preserving extension. In place of a direct application of (2.1), the method considers more broadly singular integrals of the form

$${K}_{n} ( f ; x ) = {\int }_{0}^{1} f ( t ) {ⅆ}_{t} {Φ}_{n} ( x , t ) , \qquad ( 3.1 )$$

especially in regard to analyzing data with an interest in smoothing or function recovery. Allowing the kernel Φₙ(x,t) to be constant with respect to t in each interval (k/n,(k+1)/n), k=0,1, . . . ,n,

$${Φ}_{n} ( x , t ) = \{ \begin{matrix}{\sum }_{k \leq n t} ( \begin{matrix}n \\ k\end{matrix} ) {{x}^{k} ( 1 - x )}^{n - k} , & 0 < t \leq 1 , \\ 0 , & otherwise ,\end{matrix} \qquad ( 3.2 )$$

the Bernstein polynomials (2.1) are a special case of (3.1).

Returning to the formulation of the problem in (1.1), several alternative extensions of the Bernstein polynomials can be constructed. These allow f to be sampled on the unit interval without a restriction that the points be uniformly spaced along [0,1]. The first of these extensions is achieved by generalizing the terms in the Bernstein polynomial, i.e., replacing sums with integrals, so as to achieve an area preserving extension.

Consider the continuous variable, k(t), 0≦k(t)≦n and 0≦t≦1. In moving to a continuum model, define non-uniform mesh boundaries {yₖ},k=0, . . . ,n+1, such that each sample point xₖ∈(yₖ,yₖ₊₁), k=0,1 . . . n, setting the boundaries as
yₖ=(xₖ₋₁+xₖ)/2, 0<k<n, (3.3)
The endpoint values of y₀ and yₙ₊₁ may extend beyond [0,1], e.g., −∞ and ∞, respectively. Define fₖ(x), k=0,1, . . . n such that

$${f}_{k} ( x ) = \{ \begin{matrix}f ( {x}_{k} ) & x ∈ [ {y}_{k} , {y}_{k + 1} ) , \\ 0 , & otherwise\end{matrix} \qquad ( 3.4 )$$

with an exception at the right endpoint, i.e., fₙ(yₙ₊₁)=0. Then

$$\hat{f} ( x ) = {\sum }_{k = 0}^{n} {f}_{k} ( x ) \qquad ( 3.5 )$$

is a piecewise constant interpolant to the data f on [0,1].

Denote by \hat{K}ₙ(f;x) a generalization of the Bernstein polynomials which arises from considering the continuum extension to using k(t) in (3.1) and (3.2), specifically taking

$${\hat{K}}_{n} ( f ; x ) = \frac{n + 1}{n} {\int }_{0}^{1} ( \begin{matrix}n \\ k ( t )\end{matrix} ) f ( \frac{k ( t )}{n} ) {{x}^{k ( t )} ( 1 - x )}^{n - k ( t )} ⅆ k ( t ) , \qquad ( 3.6 )$$

where the combinatorial of n items taken y at a time is defined to be

$$( \begin{matrix}n \\ y\end{matrix} ) = \frac{Γ ( n + 1 )}{Γ ( y + 1 ) Γ ( n - y + 1 )} , where 0 \leq y \leq n . \qquad ( 3.7 )$$

The factor (n+1)/n multiplying the integral in (3.6) is necessary for area preservation.

Assume a linear model for k, i.e., k(t)=nt, gives f(k(t)/n)=f(t), making it possible to analytically evaluate the integral of \hat{K}ₙ in (3.6). Thus,

$$\begin{matrix}{\int }_{0}^{1} {\hat{K}}_{n} ( f ; x ) ⅆ x = \frac{n + 1}{n} {\int }_{0}^{1} \{ {\int }_{0}^{1} ( \begin{matrix}n \\ n t\end{matrix} ) f ( t ) {{x}^{n t} ( 1 - x )}^{n - n t} n ⅆ t \} ⅆ x \\ = ( n + 1 ) {\int }_{0}^{1} ( \begin{matrix}n \\ n t\end{matrix} ) f ( t ) \{ {\int }_{0}^{1} {{x}^{n t} ( 1 - x )}^{n - n t} ⅆ x \} ⅆ t .\end{matrix} \qquad ( 3.8 )$$

Again, noting the term in braces in (3.8) is given by the Beta function B(nt+1, n−nt+1)=Γ(nt+1)Γ(n−nt+1)/(n+1)Γ(n+1), on substituting into (3.8) and using (3.7), the integral simplifies to

$${\int }_{0}^{1} {\hat{K}}_{n} ( f ; x ) ⅆ x = {\int }_{0}^{1} f ( x ) ⅆ x , \qquad ( 3.9 )$$

and strict preservation of the integral off for all n is achieved. Preserving the area, however, comes at the price of the loss of uniform approximation off by \hat{K}ₙ for each n.

As an illustration, consider the endpoint intervals [0,1/n] and [1−1/n,1], with f(x)=1. The behavior of \hat{K}ₙ=(f;p) for p∈[0,1/n] is examined (by symmetry, the other endpoint yields the same result).

$$( \begin{matrix}n \\ n t\end{matrix} ) {{z}^{n t} ( 1 - z )}^{n - n t}$$

is of one sign for all t∈[0,1],

$$\begin{matrix}{\hat{K}}_{n} ( f ; z ) = ( n + 1 ) {\int }_{0}^{1} ( \begin{matrix}n \\ n t\end{matrix} ) {{z}^{n t} ( 1 - z )}^{n - n t} ⅆ t \\ = ( \begin{matrix}n \\ n ξ\end{matrix} ) ( n + 1 ) {\int }_{0}^{1} {{z}^{n t} ( 1 - z )}^{n - n t} ⅆ t\end{matrix} \qquad ( 3.10 )$$

for some value of ξ∈[0,1]. Since

$$( \begin{matrix}n \\ n ξ\end{matrix} ) \leq {C}_{n , ,}$$

for all ξ∈[0,1], for p sufficiently small

$$\begin{matrix}0 \leq {\hat{K}}_{n} ( f ; p ) \leq {C}_{n} ( n + 1 ) {\int }_{0}^{1} {{p}^{n t} ( 1 - p )}^{n - n t} ⅆ t \\ = - {C}_{n} ( n + 1 ) ( \frac{{( 1 - p )}^{n} - {p}^{n}}{n ( ln ( p ) - ln ( 1 - p ) )} ) . \end{matrix} \qquad ( 3.11 )$$

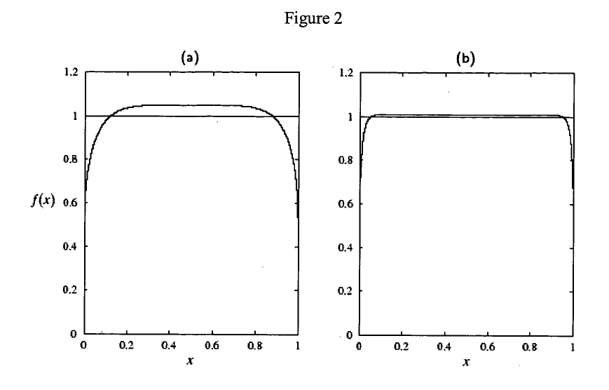

Thus, for fixed n, lim_{p→0} \hat{K}ₙ(f,p)=0, and the approximation \hat{K}ₙ(f,x) obtained from Bₙ(x) in going from a discrete to a continuum model does not to converge at the endpoint x=0 (and by a similar argument at the endpoint x=1). This behavior of \hat{K}ₙ is illustrated in FIG. 2. The difficulty at the endpoints arises because the terms x^{nt}(1−x)^{n-nt} vanish for x sufficiently near 0 or 1. In the interior of the interval, it is not difficult to see that as n→∞, \hat{K}ₙ(f;x)→f(x). Convergence for n>>1 ultimately impacts only a vanishingly small neighborhood of either endpoint of the interval. This illustrating the failure of \hat{K}ₙ to converge at the endpoints of the interval. The approximations \hat{K}ₙ are area preserving.

4. Bernstein functions. In contrast to the previous construction, a workable continuum model can be constructed motivated by the probabilistic formulation of the Bernstein polynomials. The approximations Kₙ(f;x) are built so as to assure uniform convergence throughout the interval for all x. Denote a probability distribution function, or pdf, with mean μ and variance σ² as p_{μ,σ}². Each term in the kernel of Bₙ(f;x) derives from the binomial distribution

$${p}_{μ , {σ}^{2}}^{B} ( X = k ) = {p}_{{nx}_{1} nx ( 1 - x )}^{B} ( X = k ) = ( \begin{matrix}n \\ k\end{matrix} ) {{x}^{k} ( 1 - x )}^{n - k} , \qquad ( 4.1 )$$

expressing the probability that n Bernoulli trials yield exactly k successes whenever the probability of success on each trial is x. For n sufficiently large it is natural to consider the normal pdf

$${p}_{μ , {σ}^{2}}^{N} ( X = ξ ) = {p}_{nx , nx ( 1 - x )}^{N} = \frac{1}{\sqrt{2 π} σ} {ⅇ}^{- {( ξ - μ )}^{2} / 2 {σ}^{2}} , \qquad ( 4.2 )$$

as an approximation to the binomial distribution. Thus, if n>>1,

$$( \begin{matrix}n \\ k\end{matrix} ) {{x}^{k} ( 1 - x )}^{n - k} \approx {( 2 π nx ( 1 - x ) )}^{- 1 / 2} {ⅇ}^{- {( k - nx )}^{2} / 2 nx ( 1 - x )} . \qquad ( 4.3 )$$

The generalized Bernstein polynomial Kₙ(f;x) in (3.6) can now be restructured, substituting (4.3) in place of (4.1)

$${K}_{n} ( f ; x ) = {\int }_{a}^{b} \frac{f ( k ( t ) / n )}{\sqrt{2 π n x ( 1 - x )}} {ⅇ}^{- {( k ( t ) - nx )}^{2} / 2 nx ( 1 - x )} ⅆ k ( t ) , \qquad ( 4.4 )$$

where a and b are yet to be chosen. Assuming that k(t) varies linearly in t, i.e., k(t)=nt, and defining

$$z = \frac{n t - n x}{\sqrt{2 n x ( 1 - x )}} \qquad ( 4.5 )$$

(4.4) is rewritten as

$$\begin{matrix}{K}_{n} ( f ; x ) = {\int }_{a ( n , x )}^{b ( n , x )} \frac{f ( z \sqrt{( 2 / n ) x ( 1 - x )} + x )}{\sqrt{2 π n x ( 1 - x )}} {ⅇ}^{- {z}^{2}} \\ n ( \frac{\sqrt{2 nx ( 1 - x )}}{n} ⅆ z ) \\ = \frac{1}{\sqrt{π}} {\int }_{a ( n , x )}^{b ( n , x )} f ( z \sqrt{( 2 / n ) x ( 1 - x )} + x ) {ⅇ}^{- {z}^{2}} ⅆ z .\end{matrix} \qquad ( 4.6 )$$

If z=0 and z=1 are taken as the endpoints of the interval, then

$$a ( n , x ) = \frac{- n x}{\sqrt{2 n x ( 1 - x )}} , b ( n , x ) = \frac{n - nx}{\sqrt{2 nx ( 1 - x )}} . \qquad ( 4.7 )$$

and the value of Kₙ(f;x) will again not converge properly at the endpoints, exactly as for \tilde{K}ₙ(f;x). In contrast, setting α=yₒ−∞ and b=yₙ=∞, since f(z((2/n)x(1−x))^{1/2}+x)→f(x) as n→∞,

$${lim}_{n \to ∞} {K}_{n} ( f ; x ) = \frac{f ( x )}{\sqrt{π}} {\int }_{- ∞}^{∞} {ⅇ}^{- {z}^{2}} ⅆ z = f ( x ) , \qquad ( 4.8 )$$

demonstrating that Kₙ(f;x) converges to f. This shows that to satisfy convergence at the endpoints for all n, the range of integration is extended to infinity. This definition includes the tails of the normal distribution, assuring that all of the probability is included.

Since Kₙ(f;x) is evaluated typically not based on f but on the piecewise constant approximation to f i.e., \hat{f}=Σfⱼ, the recovery off is done using

$${K}_{n} ( f ; x ) = \frac{1}{\sqrt{π}} {\int }_{- ∞}^{∞} \hat{f} ( z \sqrt{( 2 / n ) x ( 1 - x )} + x ) {ⅇ}^{- {z}^{2}} ⅆ z , x ∈ [ 0 , 1 ] \qquad ( 4.9 )$$

where \hat{f} is defined to have the values f(xₒ) in (−∞,y₁) and f(xₙ) in (yₙ,∞). The notation in denoting Kₙ(f;x) in place is of Kₙ(\hat{f};x) is consistent with the use in Bₙ(f;x).

Since fⱼ is constant in each interval (yⱼ₋₁,yⱼ), (4.9) is expressible as the sum

$$\begin{matrix}{K}_{n} ( f ; x ) = \frac{1}{\sqrt{π}} {\sum }_{j = 0}^{n} \{ {\int }_{\frac{{y}_{j} - x}{\sqrt{( 2 / n ) x ( 1 - x )}}}^{\frac{{y}_{j + 1} - x}{\sqrt{( 2 / n ) x ( 1 - x )}}} {f}_{j} ( z \sqrt{( 2 / n ) x ( 1 - x )} + x ) {ⅇ}^{- {z}^{2}} ⅆ z \} & ( 4.10 ) \\ = {\sum }_{j = 0}^{n} \frac{f ( {x}_{j} )}{2} [ erf ( \frac{{y}_{j + 1} - x}{\sqrt{( 2 / n ) x ( 1 - x )}} ) + erf ( \frac{x - {y}_{j}}{\sqrt{( 2 / n ) x ( 1 - x )}} ) ] , & ( 4.11 )\end{matrix}$$

where erf(x) is the error function and where the endpoints of each integral are chosen consistent with the definition of yⱼ in (3.3) and the transformation given by (4.5). From (4.11), it is evident that K(1;x)=1 for all x and for all n. Thus, this model has the property that Kₙ is exact for all constant functions, as is Bₙ. Note, if f is any functions such that the integral in (4.10) makes sense, then Kₙ can be computed directly from this integral, and (4.11) can be seen as a simplified collocation model of (4.10).

The computation of (4.11) is less costly than might appear. The significant cost of computing Kₙ is associated with the cost of computing the error function (which can be evaluated to lower precision to achieve significant savings), and the desire that at each point x at which the function is evaluated, that the sum be taken over all data nodes. The efficiency in this loop can be also be dramatically improved by truncating these sums to those nodes over which the contribution to the total sum is significant (typically only a few nodal difference, i.e., x−yⱼ, yield values which are significant, thus making it possible to achieve a relatively compact computational stencil).

In essence, the approximation in (4.11) consists of the weighted sum Σⱼfⱼwⱼ, where the wⱼ are the differences in the error function—a readily parallelizable task. On problems involving the same grid, the weights are computed once since they are dependent on grid geometry, i.e., on the differences x−yᵢ. Because of this, multi-blocking the grid can yield significant speedup, although at a loss of smoothness across blocks.

5. Controlling the smoothing. A connection between Kₙ in (4.11) and solutions to the heat or diffusion equation provides a method for achieving control of smoothing.

Letting t=1/n and defining uⱼ(x, 1/n) to be the j-th contribution to the sum Kₙ(f;x), and making a minor change in the form of Kₙ in (4.11), gives

$${u}_{j} ( x , t ) = \frac{f ( {x}_{j} )}{2} [ erf ( \frac{{y}_{j + 1} - x}{2 \sqrt{x ( 1 - x ) / 2} \sqrt{t}} ) + erf ( \frac{x - {y}_{j}}{2 \sqrt{x ( 1 - x ) / 2} \sqrt{t}} ) ] .$$

On setting α=x(1−x)/2≧0 and then shifting x by σⱼ=(yⱼ₊₁+yⱼ)/2,

$${u}_{j} ( x + {σ}_{j} , t ) = \frac{f ( {x}_{j} )}{2} [ erf ( \frac{L - x}{2 \sqrt{α t}} ) + erf ( \frac{L + x}{2 \sqrt{α t}} ) ] \qquad ( 5.1 )$$

where L=(yⱼ₊₁−yⱼ)/2. Further, uⱼ(x+σⱼ,t) is the solution to the partial differential equation

$$\begin{matrix}\frac{\partial {u}_{j} ( z , t )}{\partial t} = α \frac{{\partial }^{2} {u}_{j} ( z , t )}{\partial {z}^{2}} on ( - ∞ , ∞ ) and \\ u ( z , 0 ) = \{ \begin{matrix}f ( {x}_{j} ) & x ∈ ( - L , L ) \\ 0 & otherwise\end{matrix} ,\end{matrix} \qquad ( 5.2 )$$

where the initial state is determined by fⱼ in (3.4) shifted to the interval [−L,L]. The term α=x(1−x)/2 is the diffusion coefficient and there is a different differential equation for each value of x at which the Bernstein function, Kₙ(f;x) is evaluated. The construction of Kₙ(f;x) for each fixed x and n is then seen to be a discrete convolution of the solutions to the heat or diffusion equation with the function \hat{f}, i.e.,

$${K}_{n} ( f ; x ) = {\sum }_{j = 0}^{n} {f}_{j} ( x ) {u}_{j} ( x - {σ}_{j} ) .$$

With the diffusion coefficient given by α=x(1−x)/2, i.e., the standard model derived from the Bernstein polynomial, it is evident that uⱼ(0,1/n)=fᵢ(0) and uⱼ(1,1/n)=fⱼ(1). Since Σfⱼ(0)=f(0) and Σfⱼ(1)=f(1), Kₙ(f;0)=f(0) and Kₙ(f;1)=f(1), and so this Bernstein function shares the property of interpolating at the endpoints of the interval with the Bernstein polynomial.

Significant control over the smoothness of the approximant Kₙ(f,x) to f can be achieved by manipulating the value and functional form of the diffusion coefficient. It is thus appropriate to discuss a family of Bernstein functions parameterized by the function α. In choosing different values and functional forms for α, a physical analogy provided by the diffusion equation: a small value of diffusion coefficient is equivalent to a short time=1/n small. The approximation Kₙ(\hat{f},α;x) is then very near the initial condition \hat{f}. Taking the diffusion coefficient too small results in a smooth, but staircased approximation to the initial data, and taking it too large results in gross over-smoothing of all data. Clearly, α is an adjustable parameter, like λ, in (1.2).

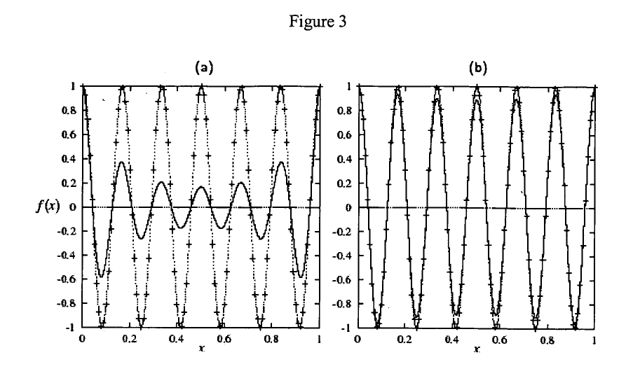

The smoothing, and hence control over the high frequency response of Kₙ is illustrated in FIGS. 3(a) and 3(b). Choosing the value of the diffusion coefficient α to be large results in a smooth approximation to f. In FIG. 3(a) the diffusion parameter used to construct K₁₀₀ is set to the same value at each x, i.e. x(1−x)/2, that it would have in the analogous Bernstein polynomial. Extensive comparisons demonstrate that Kₙ≈Bₙ for n>>20, a familiar elementary criterion often used in comparing the validity of the normal approximation to the binomial distribution. At n=100, the graph of B₁₀₀ would be visually indistinguishable from the graph of K₁₀₀. When the magnitude of α is large as in (a), K₁₀₀ is similar to the B₁₀₀ while when the magnitude of α is small, K₁₀₀ approximates f(x) well, except at the peaks of the cosine curve. Thus smoothing in Kₙ can be controlled independently of the number of data points by choosing the diffusion coefficient. In reviewing (b), it is important to realize that the error in the approximation can be made even less by choosing a much smaller, however, as α becomes vanishingly small, the function in Kₙ converges to the underlying piecewise constant data \hat{f}.

For practical purposes in working numerically with these approximations, Kₙ is Bₙ when applying the standard diffusion model and for a uniformly spaced grid on [0,1]. However, by choosing the value of α to be small, as is illustrated in FIG. 3(b), it is possible to significantly improve the quality of the approximation, i.e., the responsiveness of the Bernstein function to higher frequencies. This is visibly apparent when comparing FIG. 3(b) with FIG. 3(a). The error between K₁₀₀ and the sampled function f(x) is significantly less. Indeed, extensive studies show that the approximations achieved by using Bernstein functions are nearly interpolating (i.e., barely missing the data points only at points of rapid change in the function), while retaining the ability to approximate the data without introducing any spurious extrema (overshoots and undershoots). Thus, it is now possible to tune the performance of the Bernstein approximation, where necessary.

6. Assessment. In going to a continuous model, the conservation of the area under the curve of \hat{f} is limited. In (4.11), even on a uniform mesh using the standard diffusion model, the probabilities associated with each node xⱼ produced by the normal distribution will not equal those produced by the binomial distribution, and the discrepancy is easily detected numerically for small n. For large n, however, since the binomial distribution approaches the normal distribution, the nodal probabilities converge, and so the area under Kₙ(f;x) approaches the area under Bₙ(f;x) for n sufficiently large. Indeed, by examining the difference between the binomial and Gaussian distributions, it is possible to show that for sufficiently large n, all of the convergence properties of the Bernstein polynomials are inherited by the Bernstein functions.

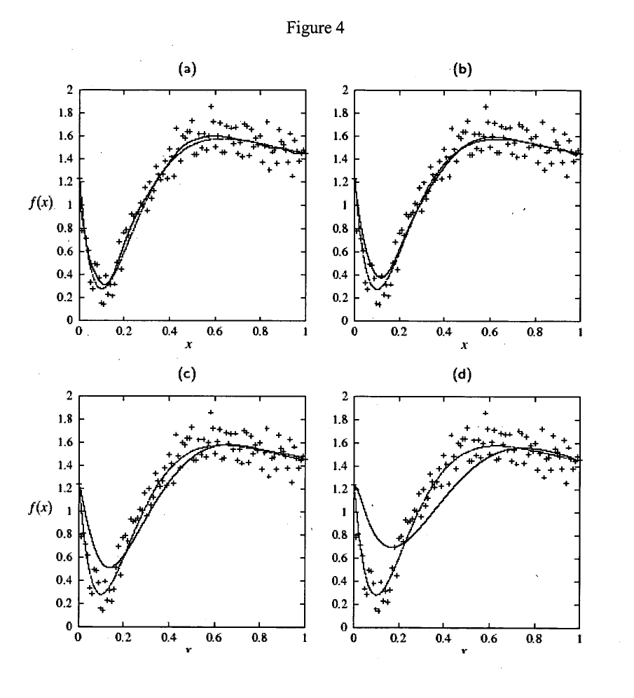

The significant advantage of the Bernstein functions as given by (4.11) over the Bernstein polynomials is that the smoothing can be made independent of the number of data points, (xⱼ,fⱼ), and the approximation can be done on irregular meshes, even for very large n, to yield smooth approximants. While a priori optimal estimates are elusive, in practical applications, the results are consistently satisfactory in numerical studies in which Kₙ is computed using the standard diffusion model or using a constant value, α=½. To achieve independence of the smoothing from the number of sample points n (and thus avoid the correlation between sample size and smoothing that affected the Bernstein polynomials), the term 1/(αt)^{1/2}=1/(α/n)^{1/2} in the argument of the error function can be scaled to account for the affects of changing n. Since Kₙ behaves as nicely as Bₙ, without the drawbacks of Bₙ, one may illustrate the performance of Kₙ in a realistic setting, i.e., comparing it to other methods. The recovery technique in this case is directly compared to results from G. WAHBA, Spline models for observational data, 59, in CBMS-NSF Regional Conference Series in Applied Mathematics, SIAM, Philadelphia, 1990, pp. 45-57. In this problem a smooth function, u(x)=4.26(e^{-3x}−4e^{-6x}+3e^{-9x})+1.28, is uniformly sampled at discrete values after perturbation by random high frequency noise. The perturbed function f is generated using a normal distribution N(0,1) scaled by 0.2 (using variants taken from S. MEYER, Data Analysis for Scientists and Engineers, Wiley, New York, 1975, pp. 446-447, to allow for comparison). The methods obtains K,(fx) so that it approximates u well. These results are shown in FIG. 4(a)-(d).

Qualitatively, the function recovery in FIG. 4(a) which results from using the standard values of α are as satisfactory as the recovery off obtained by Wahba using OGV (ordinary cross validation for choosing a smoothing parameter). The curve K₁₀₀(x) is neither excessively oscillatory, nor over-damped. The remaining graphs in FIGS. 4(b)-(d) show the results of increasing the diffusion coefficient over a wide range, demonstrating that Kₙ can be tuned select the desired smoothness.

7. Method Extensions Since the Bernstein polynomials are area preserving, a family of alternative approximations to a given function u may be constructed. Of the possible options considered, the Bernstein functions, or Kₙ, most closely match some of the elementary and desirable properties of the Bernstein polynomials, while adding new features not associated with polynomial approximation.

The use of Bernstein polynomials and Bernstein functions for approximating data is seen to arise in a natural way from a discrete convolution involving solutions of the diffusion equation. Adopting the continuous basis using error functions in place of the polynomial basis used in the Bernstein polynomials:
1. Allows for flexible control over smoothing;
2. Improves computational efficiency for large n; and,
3. Permits the use of non-uniformly spaced data.
   This is achieved while retaining many of the intrinsic analytical properties of the Bernstein polynomials.

Constructing Kₙ for the purpose of smoothing or function recovery is a possible alternative to more conventional methods. Since the parameter ax in the diffusion model of the Bernstein function can be tuned to be shape sensitive, this demonstrates how to extend the technique to adaptively construct approximations over a wide range of data. The approximation using Bernstein functions can be constructed to provide a usable alternative method for approximating data.

The Bernstein function Kₙ, may be applied to problems in engineering and computational science where constructing smooth, exceedingly well behaved approximations to large data sets often arises. As noted, this approach to approximation can be conveniently extended to include interpolation as well, and the entire development can be subsumed using a stochastic framework which provides a more suitable basis for discussing area conservation, as well as other analytical and computational issues.

8. Data Regularization. Data regularization has historically been accomplished with a range of well developed mathematical tools. Whether the interest is in approximation or interpolation, various techniques such as least squares, Fourier, wavelet and other transform methods can be applied. Both approximation and interpolation are typically implemented as a linear, or linearized problem using a variety of basis functions, including polynomials, rational functions, trigonometric polynomials and exponential functions. The Bernstein functions can also be used to interpolate the same data. Indeed, the extension of Bernstein approximations to the process of data interpolation represents only a special example of stochastic interpolation achieved through the use of a convolution-deconvolution approach to interpolation. Any linear mollifier which can be used to construct a normalized approximation method can provide a stochastic interpolation method.

Stochastic interpolation is described by examining the diffusion analogy in which the Bernstein approximation is seen as a discrete convolution of the data {(xₖ,fₖ)} with the error function. Interpolation is then a two step process in which the data are deconvolved to construct a pre-image set {(xₖ,pₖ)}. Convolving this pre-image set, using an extension of the convolution operator that was used to construct the pre-image, results in a function that interpolates the data {(xₖ,fₖ)}. If the convolution is smooth, as is the case with the Bernstein functions, this results in a function that varies smoothly between interpolated points, thus assuring that the curve connecting all of the data is also C^{∞}, i.e., it includes no loss of differentiability at any knot, or node points.

Although Bernstein interpolation is a special case of stochastic interpolation (using the Bernstein functions) the technique possesses attributes that make it particularly attractive. This approach yields exceedingly high quality results which work well including when interpolating data sampled from functions which cause other methods, notably polynomial interpolation methods, to fail. Also, the convolution-deconvolution which is constructed to accomplish the interpolation is linear and therefore includes only matrix algebra to solve the problem. Since the construction is linear, it can be done using a Bernstein basis, making the task of working with Bernstein interpolation no more difficult, or computationally expensive, than working with ordinary polynomial interpolation using the Lagrange polynomial.

While Bernstein interpolation can introduce some spurious wiggles, like many other numerical interpolation schemes, the quality of the interpolation is often significantly higher than for many comparable methods, and it is relatively free of unhelpful behaviors exhibited by other methods in the region of large gradients. These properties derive from the smoothing properties of the Gaussian inherent in the definition of the Bernstein function, and are closely related to the analytical properties of the Bernstein polynomials.

Furthermore, since the smoothing inherent in the Bernstein functions can be selected by varying the parameter α, there is substantial control over the output, particularly when attempting to interpolate extremely rough data. This allows for the management of any overshoots and undershoots in the vicinity of large gradients, similar to the tension which can be applied to many interpolating splines.

9. Constructing Bernstein Interpolation. The description of Bernstein interpolation formally begins with the definition of the convolution process involving Bernstein functions, i.e.,

$${K}_{n} ( f , α ; s ) = {\sum }_{k = 0}^{n} \frac{{y}_{k}}{2} [ erf ( \frac{{z}_{k + 1} - s}{2 \sqrt{α / n}} ) - erf ( \frac{{z}_{k} - s}{2 \sqrt{α / n}} ) ] , \qquad ( 9.1 )$$

where the smoothing inherent in Kₙ depends on α, the diffusion coefficient, and where s corresponds to a point at which Kₙ is evaluated. The assumption is that the data {(xₖ,yₖ)} are obtained from a smooth function, u, which has been perturbed by random errors, ε, i.e., yₖ=f(xₖ)=u(xₖ)+εₖ with all data lying in [0,1]. As before, the zₖ are taken as midpoint cell boundaries, i.e., zᵢ=(xᵢ₊₁−xᵢ)/2, with z₀=−∞ and zₙ₊₁=∞.

Bernstein approximation, as described in (9.1), can be viewed as being accomplished by constructing the matrix Aₘₙ=(αᵢⱼ). Each entry in the matrix includes the term

$${a}_{i j} = erf ( \frac{{z}_{j + 1} - {s}_{i}}{2 \sqrt{α / n}} ) - erf ( \frac{{z}_{j} - {s}_{i}}{2 \sqrt{α / n}} ) , \qquad ( 9.2 )$$

so that the i-th row of Aₘₙ includes data pertaining to the sᵢ-th point, i=0, . . . , m, at which Kₙ is evaluated, while each column, j=0, . . . , n, includes the terms weighting this data by the window (zⱼ,zⱼ₊₁) corresponding to the data point (xⱼyⱼ). Expressed as a matrix operation, Bernstein approximation amounts to evaluating
Kₙ(y,α;s)=Aₘₙy, (9.3)
where s=(s₀,s₁, . . . ,sₘ), and y=(y₀,y₁, . . . ,yₙ). Note, the nonstandard notation on the size of A, i.e., Aₙₙ instead of A_{n+1,n+1} to avoid notational complexity.

When m=n it is possible not only to convolve the vector y as in (9.3), but to uniquely deconvolve it, i.e., to find the pre-image p such that
Aₙₙp=y. (9.4)
Each row of Aₙₙ can be shown to be linearly independent—being generated by a normal probability distribution function (pdf) with different mean for each row. Thus the inverse of Aₙₙ always exists. This yields the pre-image data {(xᵢ,ρᵢ)} corresponding to the data {(xᵢ,yᵢ)}. Constructing the Bernstein function approximation Kₙ(ρ;x) to the pre-image {(xᵢ,ρᵢ)} using the same diffusion model as was used to construction Aₙₙ yields the identity operator,
Aₙₙp=Aₙₙ(Aₙₙ⁻¹y)=y. (9.5)
since AₙₙAₙₙ⁻¹=I. The extension to constructing a workable interpolation method is now described.

Interpolation of data starts with constructing the matrix Aₙₙ that is used to deconvolve the data, and an extended matrix Ãₘₙ to convolve the pre-image. To construct A_{nn,} select each approximation point such that sᵢ=xᵢ. For the extended matrix Ãₘₙ each row is obtained by evaluating (9.2) at points sᵢ,i=1, . . . ,m which lie at or between the values in the set {xᵢ},i=0, . . . ,n, i.e., choosing sᵢ such that x₁≦sᵢ≦xₙ, i=0, . . . m. Thus, Bernstein interpolation is given by
Ãₘₙp=ÃₘₙAₙₙ⁻¹y (9.6)
Clearly, if the i-th row of Ãₘₙ corresponds to a row generated by evaluating the Bernstein function at sᵢ=xₗ for some l, then at this point the interpolation has exactly the value of yₗ.

From the viewpoint of computational efficiency, having to invert Aₙₙ is expensive, particularly since each entry of Aₙₙ is nonzero, thus causing the calculation of the inversion of a full matrix. For large n, this can become very expensive. In most cases in which a smooth interpolation through all of the n data points is not required, a solution is simply to construct block methods in which the interpolation is applied across blocks. Where it is important to construct a smooth interpolating function through all n data points, there are considerable gains in efficiency which can be achieved if the grid remains constant and only the data values y change.

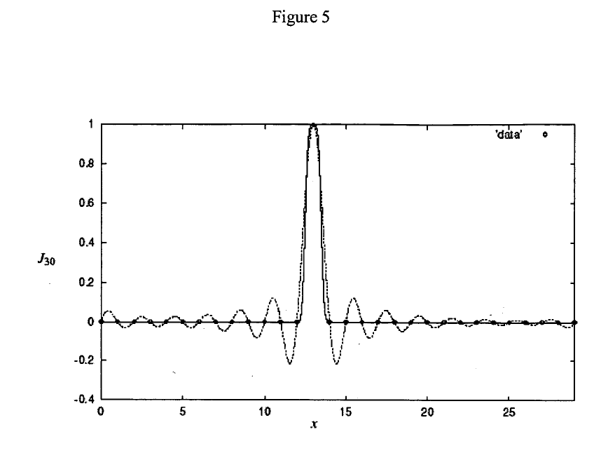

Consider the repeated interpolation on a fixed grid, in which the number of points n and m are fixed, as are the locations of the input data points x and output data points s. In this case it is worthwhile constructing a Bernstein function basis to substantially increase the efficiency of Bernstein interpolation. This construction uses the solution of n+1 linear problems
Aₙₙpₖ=eₖ, k=0, . . . ,n, (9.7)
where eₖ is the k-th unit basis vector, i.e. eₖ=(0, . . . ,1, . . . 0)^{t}, in which 1 occurs in the k-th position. By evaluating
Ãₘₙpₖ=bₖ (9.8)
a set of Bernstein bases, {bₖ}k=1, . . . ,m is obtained. The Bernstein interpolation is constructed directly from this basis as

$${J}_{m} ( y , α ; s ) = {\sum }_{k = 1}^{n} {y}_{k} {b}_{k} , \qquad ( 9.9 )$$

where Jₘ is used to denote Bernstein interpolation using the parameter a with input data y which are evaluated at s. As with Bernstein approximation, choosing different values for α can dramatically alter the performance of the interpolation method. This is shown in FIG. 5 in which the basis element b₁₄ for n=30 is constructed using two different values of α.

The primary computational costs of Bernstein interpolation are associated with solving the linear system involving the full matrix Aₙₙ and then with evaluating the product AₙₙAₙₙ⁻¹ n times to construct a Bernstein basis. Additionally, there are 2(n²+nm) evaluations of the error function.

10. The construction of stochastic interpolation methods. In casting Bernstein approximation and interpolation in the context of matrix algebra, it is evident that each row of Aₙₙ or Ãₘₙ sums to one (as it consists of the normal distribution integrated from −∞ to ∞). Thus each of these are row stochastic matrices. While the product of row stochastic matrices is also row stochastic, interpolation is accomplished through the product ÃₘₙAₙₙ⁻¹ which is only row sum one, and thus formally is not stochastic. If A is row stochastic and invertible, then its inverse has rows which also sum to one (although they may not all be composed of non-negative entries). The product of row sum one matrices is also row sum one, since the vector 1=(1, 1, . . . 1) is an eigenvector with eigenvalue 1 for both stochastic and row sum one matrices. Nevertheless, the entire discussion on Bernstein interpolation can be interpreted using stochastic matrices (or their inverses which are row sum one), allowing for the construction of a broad range of stochastic interpolation schemes beyond the Bernstein scheme already discussed.

For example, Lagrange polynomial interpolation can be viewed as row sum one interpolation since the Lagrange polynomials also have the property that they interpolate the constant function exactly, i.e., they can be used to construct a one row stochastic matrix in which the generator of the row space is the Lagrange function, i.e., letting

$${l}_{1 j} ( x ) = {\prod }_{{i = 0}_{i \neq j}}^{n} \frac{x - {x}_{i}}{{x}_{j} - {x}_{i}} , j = 0 , … , n , \qquad ( 10.1 )$$

interpolation is given by the one row matrix product,
Ly=(l₁₀,l₁₁, . . . ,l₁ₙ)y (10.2)

In order to construct a stochastic interpolation method using the approach suggested by Bernstein interpolation, the extended matrix, as with Bernstein approximation, will approximate the data, i.e., it will act as a mollifier, and even more significantly, there will be a convenient mechanism for constructing the row space of the extended matrix (the normal pdf for Bernstein interpolation and the Lagrange function for polynomial interpolation). Thus, any mollifier which can be discretized and normalized to yield a pdf can be used to construct a Bernstein function interpolation scheme. Furthermore, the interpolant inherits the smoothing properties of the mollifier, which is an advantage that will be demonstrated below. This approach to interpolation extends easily to multiple dimensions, and full multi-dimensional interpolation schemes can be constructed using this approach by using multivariate pdfs to weight the data.

The construction of the inverse of the matrix Aₙₙ for large n can be computationally intensive in Bernstein interpolation, as discussed, so it is desirable to attempt to construct schemes which minimize this computational expense. One approach is to construct Aₙₙ such that Aₙₙ⁻¹ is easily computable. Since Aₙₙ is row stochastic, it suffices to choose Aₙₙ¹ to be row sum one. To illustrate this approach, consider the discrete Laplacian (i.e., the discrete second difference based on the three point divided difference stencil [−1,2,−1]). For example the tridiagonal row sum one matrix

$${L}_{33} = ( \begin{matrix}2 & - 1 & 0 \\ - 1 & 2 & - 1 \\ 0 & - 1 & 2\end{matrix} ) \qquad ( 10.3 )$$

is easily invertible (and its inverse is row stochastic). For every such matrix Lₙₙ, there exists a diagonal scale matrix Dₙₙ such that DₙₙLₙₙ⁻¹ is stochastic, and where the entries of Dₙₙ are the reciprocals of the corresponding row sums for each row of Lₙₙ⁻¹, e.g., for the 3×3 case being considered,

$${D}_{33} {L}_{33}^{- 1} = ( \begin{matrix}2 / 3 & 0 & 0 \\ 0 & 1 / 2 & 0 \\ 0 & 0 & 2 / 3\end{matrix} ) ( \begin{matrix}3 / 4 & 1 / 2 & 1 / 4 \\ 1 / 2 & 1 & 1 / 2 \\ 1 / 4 & 1 / 2 & 3 / 4\end{matrix} ) \\ = ( \begin{matrix}1 / 2 & 1 / 3 & 1 / 6 \\ 1 / 4 & 1 / 2 & 1 / 4 \\ 1 / 6 & 1 / 3 & 1 / 2\end{matrix} ) = {A}_{33} , \qquad ( 10.4 )$$

and A₃₃ is stochastic. Working with Lₙₙ incurs the expense of solving, i.e., inverting a tridiagonal matrix.

A Bernstein-style interpolation scheme can be built by developing a mechanism for constructing the extended matrix Aₘ₃,m>3. For example, piecewise linear interpolation on the columns of A₃₃, expanding from three rows to five will yield the interpolation scheme based on the extended matrix

$${A}_{53} = ( \begin{matrix}1 / 2 & 1 / 3 & 1 / 6 \\ 3 / 8 & 5 / 12 & 5 / 24 \\ 1 / 4 & 1 / 2 & 1 / 4 \\ 5 / 24 & 5 / 12 & 3 / 8 \\ 1 / 6 & 1 / 3 & 1 / 2\end{matrix} ) . \qquad ( 10.5 )$$

The construction in (10.5), however, yields only a piecewise linear interpolant, and it is evident that to construct useful stochastic interpolation methods, there is a use for having a convenient generator of the row space of Aₙₙ. This generator is easily created, though, using mollifiers which are normalized to yield a pdf which is associated with each row of A. Combining these as with the Bernstein matrix, yields the necessary row stochastic matrices to do stochastic interpolation.

Finally, the construction involving the product ÃₘₙAₙₙ⁻¹ can be accomplished by choosing values of α to be different on each step, i.e. Ãₘₙ (α_{α})Aₘₙ⁻¹(α₂). If α₁≠α₁, then the row space of Ãₘₙ is different from that of Aₙₙ, hence the product ÃₘₙAₙₙ⁻¹ will not be interpolating. Choosing α₂>α₁ will result in an approximation scheme, but selecting α₁>α₂ leads to a variety of deconvolution schemes with peak sharpening, and high frequency detail enhancement.

11. Interpolation performance. The success of any interpolation method is determined by how well it interpolates rough, or noisy data. Bernstein-Gauss interpolation works well with smooth functions (sampled either uniformly or even non-uniformly), however many alternative interpolation methods do well in this case, and may be less expensive to compute, at least in the case where blocking is not used.

Almost all interpolation methods fail in attempting to interpolate data with abrupt changes, e.g., a step function. Cubic splines perform poorly, and most interpolation methods exhibit increasingly oscillatory behavior as the size of the mesh is reduced. In contrast, the Bernstein interpolation of step functions can be dealt with effectively. Although the Bernstein interpolants do not share the same monotonicity properties that the Bernstein polynomial and Bernstein function approximants do, they are still remarkably controllable when interpolating even discontinuous functions. This has already been demonstrated in FIG. 5 (in the discussion on the Bernstein basis). Note that by selecting a sufficiently small, the oscillation of the interpolation function is almost completely eliminated. Clearly, adaptively controlling the magnitude of the local diffusion parameter can provide the necessary control on smoothing in most applications.

While analytical estimates for non-compact operators are difficult to extract, the observed convergence of the Bernstein-Gauss interpolant when sampling smooth functions is comparable to trigonometric interpolation with rapid convergence (in most cases to within machine precision as the number of interpolation points is increased from 10 to 100). Numerical studies verify that the maximum error in Bernstein interpolation vanishes as fast as h⁶ when interpolating smooth functions. The observed rate of convergence also depends on the choice of diffusion coefficient. A value which is excessively small or large is observed to slow the rate of convergence. Since α→0 gives a piecewise constant interpolant, the convergence cannot be more than O(h) for vanishing values of α. Alternatively, too large an α, e.g., >>1, causes difficulties in numerically inverting Aₙₙ as each entry αᵢⱼ in each row becomes numerically indistinguishable from entries in nearby rows.

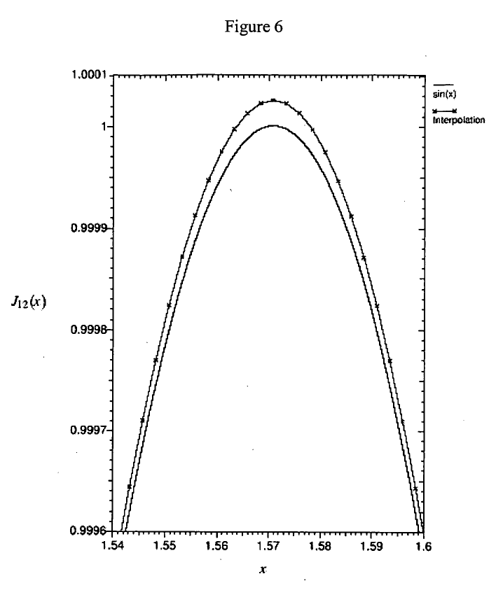

Due to the rapid convergence of Jₙ, it is difficult to illustrate the quality of the interpolation method graphically, except on coarse grids. For example, comparing the graph of the function f(x)=sin(x) sampled at 12 uniformly spaced points on [0,2π] to the graph of its interpolant J₁₂ on [0,2π] produces a figure in which the graphs are indistinguishable. FIG. 6 shows these graphed in the narrow region centered on the interval including the maximum value of f occurring at π/2, showing a maximum error of less than 0.06%.

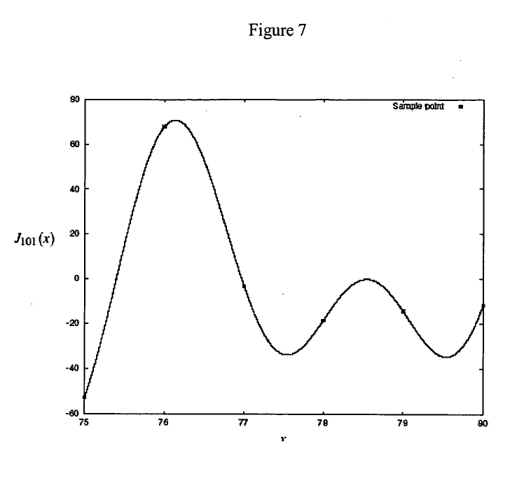

Most significantly, even when there are no sample points anywhere near the extrema of f, Jₙ appears to have little difficulty correctly achieving these extrema provided that the sampling is sufficient to avoid aliasing errors. This is illustrated in FIG. 7 in which the oscillatory function f(x)=x cos(x/2)sin(2x) is sampled on the integers from 0 to 100. Note that although none of the local maxima or minima of f(x) are being sampled, the graphs off and the Bernstein interpolant J₁₀₁ overlay each other (the maximum error is less than 10⁻⁶). In this case there are typically only about two to three samples in each sinusoidal oscillation off, or about the minimum for avoiding aliasing errors.

Finally, there is the question of preserving the area under the graph of piecewise constant sampling off. The area under the Bernstein polynomial approximating the data {(xₖ,yₖ)}, k=0, . . . , n has been shown to be equal to the area under the (piecewise constant) data. In the matrix formulation of the approximation problem, the area under {(xₖ,yₖ)} is not the same as the discrete area under the approximant since

$$\frac{1}{n + 1} {\sum }_{k = 0}^{n} {y}_{k} \neq \frac{1}{n + 1} {\sum }_{k = 0}^{n} {A}_{nn} {y}_{k} \qquad ( 11.1 )$$

where Aₘₙ is the Bernstein row stochastic matrix. For example, even when the generator of the row space of Aₘₙ is a Bernstein polynomial, these sums will not be equal. For example, when m=3 an n=3,

$${A}_{33} = ( \begin{matrix}1 & 0 & 0 & 0 \\ 8 / 27 & 4 / 9 & 2 / 9 & 1 / 27 \\ 1 / 27 & 2 / 9 & 4 / 9 & 8 / 27 \\ 0 & 0 & 0 & 1\end{matrix} ) , \qquad ( 11.2 )$$

and for anything other than constant or linear data, the two sums in (11.1) are not equal. Equality can be achieved if the matrices were doubly stochastic, or doubly sum one (i.e., the rows and columns added to one). This is because if {cⱼ} are the elements of the column space of Aₘₙ, i.e., where cⱼ is the j-th column of Ãₘₙ, then

$${\sum }_{k = 1}^{n} ( {\sum }_{j = 1}^{n} {y}_{j} {c}_{kj} ) = {\sum }_{j = 1}^{n} {y}_{j} ( {\sum }_{k = 1}^{n} {c}_{kj} ) = {\sum }_{j = 1}^{n} {y}_{j} \qquad ( 11.3 )$$

and the discrete area, in the sense of (11.1) is preserved. Another approach to constructing matrices which are doubly stochastic using the Bernstein functions is to redefine αᵢⱼ in (9.2) by adjusting the values of zᵢ and zᵢ₊₁ so that the resulting matrix is doubly stochastic.

12. Other Observations The development of a unified approach to data regularization combining approximation and interpolation was described with an observation on the area preserving properties of the Bernstein polynomials and a desire to construct computable approximations which share this property. These led to the development of the Bernstein functions and the extension to Bernstein interpolation came from the observation that Bernstein function approximation represents a discrete convolution of the data being approximated. Hence, a useful interpolation scheme is constructed by implementing a discrete deconvolution-reconvolution process.

For interpolating particularly rough or noisy data, the Bernstein interpolation technique using Bernstein functions appears to provide a robust mechanism for producing smooth interpolants which are relatively free of spurious artifacts. The construction gives rise to interpolants which are infinitely differentiable over the entire domain, not just twice differentiable as cubic splines, or other spline methods. They can be constructed to be ripple-free, unlike polynomial or trigonometric interpolants.

Both Bernstein approximation and interpolation generalize to a broader set of methods built around the product of row sum one matrix products, thus connecting approximation and interpolation. Any approximation scheme in which a mollifier which can be normalized to yield a pdf, and hence a stochastic matrix, can be used to construct an interpolation scheme. As most of the computational procedures described involve nothing more than the accumulation of sums in which order does not matter, or inverting and multiplying matrices, the approach is highly parallelizable using standard tools already developed for parallelizing matrix algebra. The Bernstein approach is effective in a broad range of application problems. These include image analysis and the approximation of large, noisy data sets to filter noise.

The construction described can be extended to a range of problems involving the discrete representation of functions, including the computation of derivatives (which are easily constructed as the linear combinations of sums of squares of exponential functions). Thus the method applies to solving numerical problems involving partial differential equations.

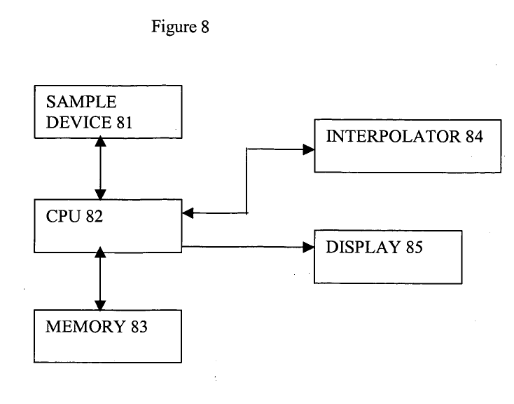

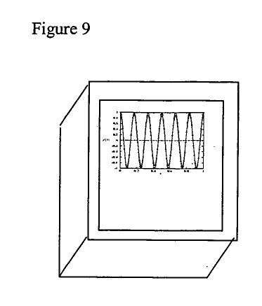

An embodiment of the system is described in FIG. 8, a sampling device 81 acquires samples (data) 80 under an appropriate format (e.g., fan-beam CT, spiral CT, etc.) under the control of a central processing unit (CPU) 82. The CPU 82 may store the samples in a memory unit 83 or process the samples directly. Once collected, the samples may be transferred to an interpolator 84. Within the interpolator 84, the samples may be interpolated under the control of the CPU 82. Once converted, the samples may be displayed under a conventional format on a display 85. The modules 81-85 may communicate to each other through software and/or hardware interfaces. The modules 81-85 include logic to perform the functions of the modules. The logic may be any combination of hardware of software. FIG. 9 is a diagram of a display showing an interpolation created by the present invention. Such a display may be used by an operator to determine the accuracy of interpolation.

1. A method of stochastic data regularization including the steps of:
inputting a set of input data elements, wherein each input data element includes a position and a value;
constructing a stochastic convolution matrix using positions of the input data elements;
creating and applying the inverse of the stochastic convolution matrix to the values of the set of input data elements to create a preimage of the data;
constructing a stochastic reconvolution matrix consistent with the stochastic convolution matrix using desired positions for a set of output data elements; and
applying the stochastic reconvolution matrix to the preimage of the data to create the set of output data elements.

2. The method of claim 1, wherein the position is implicit.

3. The method of claim 1, wherein the position is explicit.

4. The method of claim 1, wherein the stochastic convolution matrix and stochastic reconvolution matrix are constructed with the use of a Bernstein Function.

5. The method of claim 1, wherein the stochastic convolution matrix and stochastic reconvolution matrix are constructed with the use of a Bernstein Polynomial.

6. The method of claim 4, wherein the Bernstein Function is Kₙ(f,α;s)=
$${\sum }_{k = 0}^{n} \frac{{y}_{k}}{2} [ erf ( \frac{{𝓏}_{k + 1} - s}{2 \sqrt{α / n}} ) - erf ( \frac{{𝓏}_{k} - s}{2 \sqrt{α / n}} ) ] .$$

7. The method of claim 1, wherein the input data elements are unit coordinate vectors in a vector space.

8. The method of claim 1, wherein stochastic data regularization includes interpolation.

9. The method of claim 1, wherein stochastic data regularization includes data recovery.

10. The method of claim 1, wherein stochastic data regularization includes data deconvolution.

11. The method of claim 1, wherein the stochastic convolution matrix and stochastic reconvolution matrix are constructed with the use of a normalized convolution operator.

12. A method of stochastic data regularization including the steps of:
inputting a set of input data elements, wherein each input data element includes a position and a value;
constructing a stochastic convolution matrix using the positions of the input data elements and the positions of output data elements; and
applying the stochastic convolution matrix to the values of the set of input data elements to create a set of output data.

13. The method of claim 12, wherein the stochastic convolution matrix is constructed with the use of a Bernstein Function.

14. The method of claim 12, wherein the position is explicit.

15. The method of claim 13, wherein the Bernstein Functions is Kₙ(f,α;s)=
$${\sum }_{k = 0}^{n} \frac{{y}_{k}}{2} [ erf ( \frac{{𝓏}_{k + 1} - s}{2 \sqrt{α / n}} ) - erf ( \frac{{𝓏}_{k} - s}{2 \sqrt{α / n}} ) ] .$$

16. The method of claim 12, wherein the input data elements are unit coordinate vectors in a vector space.

17. The method of claim 12, wherein stochastic data regularization includes data approximation.

18. The method of claim 12, wherein stochastic data regularization includes data recovery.

19. The method of claim 12, wherein stochastic data regularization includes data error filtration.

20. The method of claim 12, wherein stochastic data regularization includes smoothing.

21. The method of claim 12, wherein the stochastic convolution matrix is constructed with the use of a normalized convolution operator.

22. A system for interpolation of data points including:
a first interface configured to receive data points including a position and a value;
a computation module connected to the first interface including logic configured to:
construct a stochastic convolution matrix using positions of the received data points;
create and apply the inverse of the stochastic convolution matrix to the values of the set of input data points to create a preimage of the received data points;
construct a stochastic reconvolution matrix consistent with the stochastic convolution matrix using desired positions for a set of output data points; and
apply the stochastic reconvolution matrix to the preimage of the data to create the set of output data points; and
a second interface connected to the computation module configured to output the set of output data points.

23. The system for interpolation of data of claim 22, wherein the logic is hardware.

24. The system for interpolation of data of claim 22, wherein the logic is software.

25. The system for interpolation of data of claim 24, wherein the logic includes both hardware and software.

26. The system of claim 22, wherein the input data points are unit coordinate vectors in a vector space.

27. The system of claim 22, wherein stochastic data regularization includes at least one of interpolation, data recovery and data deconvolution.

28. The system of claim 22, wherein the stochastic convolution matrix and stochastic reconvolution matrix are constructed with the use of a Bernstein Function.

29. The system of claim 22, wherein the stochastic convolution matrix and stochastic reconvolution matrix are constructed with the use of a Bernstein Polynomial.

30. The system of claim 22, wherein the stochastic convolution matrix and stochastic reconvolution matrix are constructed with the use of a normalized convolution operator.

31. A system for approximation of data points including:
a first interface configured to receive data points including a position and a value;
a computation module connected to the first interface including logic configured to:
construct a stochastic convolution matrix using the value and positions of received data points and position of output data points; and
create and apply the stochastic convolution matrix to the values of the set of input data points to create output data points including a position and a value; and
a second interface connected to the computation module configured to output the output data points.

32. The system of claim 31, wherein the stochastic convolution matrix is constructed with the use of a Bernstein Function.

33. The system of claim 31, wherein the position is explicit.

34. The system of claim 31, wherein stochastic data regularization includes at least one of data approximation, data recovery, data error filtration and smoothing.

35. The system of claim 31, wherein the stochastic convolution matrix is constructed with the use of a normalized convolution operator.

36. A method of stochastic data regularization including the steps of:
inputting a set of input data elements, wherein each input data element is a unit coordinate vector and includes a position and a value;
constructing a stochastic convolution matrix using the position of the input data elements, a normalized convolution operator and Bernstein Functions;
creating and applying the inverse of the stochastic convolution matrix to the values of the set of input data elements to create a preimage of the data;
constructing a stochastic reconvolution matrix with Bernstein Functions and a normalized convolution operator, consistent with the stochastic convolution matrix using desired positions for a set of output data elements; and
applying the stochastic reconvolution matrix to the preimage of the data to create the set of output data elements; and wherein
the Bernstein Function is Kₙ(f,α;s)=
$${\sum }_{k = 0}^{n} \frac{{y}_{k}}{2} [ erf ( \frac{{𝓏}_{k + 1} - s}{2 \sqrt{α / n}} ) - erf ( \frac{{𝓏}_{k} - s}{2 \sqrt{α / n}} ) ] .$$
